(19) United States
(12) Patent Application Publication
(10) Pub. No.: US 2017/0080817 A1
(43) Pub. Date: Mar. 23, 2017

(54) SYSTEM AND METHOD FOR CHARGING ELECTRIFIED VEHICLES

(71) Applicant: FORD GLOBAL TECHNOLOGIES, LLC, Dearborn, MI (US)

(72) Inventors: Robert David HANCASKY, Royal Oak, MI (US); Bryan Michael BOLGER, Canton, MI (US); Karin LOVETT, Novi, MI (US)

(21) Appl. No.: 14/859,682

(22) Filed: Sep. 21, 2015

(51) Int. Cl. B60L 11/18

(52) U.S. Cl. CPC B60L 11/1844; B60L 11/182; B60L 11/1816

(57) ABSTRACT

A method according to an exemplary aspect of the present disclosure includes, among other things, controlling charging of a battery pack of an electrified vehicle including prioritizing charging using a wired charging system over a wireless charging system if power is available from both the wired charging system and the wireless charging system.

### TECHNICAL FIELD

This disclosure relates to a vehicle system and method for an electrified vehicle. The vehicle system is adapted to control charging of the electrified vehicle by prioritizing wired charging over inductive charging when both are available.

### BACKGROUND

The need to reduce automotive fuel consumption and emissions is well known. Therefore, vehicles are being developed that reduce or completely eliminate reliance on internal combustion engines. Electrified vehicles are one type of vehicle currently being developed for this purpose. In general, electrified vehicles differ from conventional motor vehicles because they are selectively driven by one or more battery powered electric machines. Conventional motor vehicles, by contrast, rely exclusively on the internal combustion engine to drive the vehicle.

A high voltage battery pack typically powers the electric machines and other electrical loads of the electrified vehicle. The battery pack includes a plurality of battery cells that must be periodically recharged to replenish the energy necessary to power these vehicle loads. The battery packs of some electrified vehicles can be wirelessly charged or charged using a power cord that plugs into a charging port.

### SUMMARY

A method according to an exemplary aspect of the present disclosure includes, among other things, controlling charging of a battery pack of an electrified vehicle including prioritizing charging using a wired charging system over a wireless charging system if power is available from both the wired charging system and the wireless charging system.

In a further non-limiting embodiment of the foregoing method, the method includes inhibiting the charging if the electrified vehicle is not in park.

In a further non-limiting embodiment of either of the foregoing methods, the method includes inhibiting the charging if a parking brake is not applied.

In a further non-limiting embodiment of any of the foregoing methods, the method includes inhibiting the charging if the electrified vehicle is not in park and a parking brake is not applied.

In a further non-limiting embodiment of any of the foregoing methods, the method includes switching to wireless charging using the wireless charging system if power from the wired charging system becomes unavailable.

In a further non-limiting embodiment of any of the foregoing methods, the method includes determining whether the electrified vehicle is in PARK, determining whether a parking brake of the electrified vehicle is applied and inhibiting the charging if the electrified vehicle is not in PARK and the parking brake is not applied.

In a further non-limiting embodiment of any of the foregoing methods, the controlling step includes determining whether the wired charging system is available for charging the battery pack.

In a further non-limiting embodiment of any of the foregoing methods, the method includes charging the battery pack using the wireless charging system if the wired charging system is unavailable.

In a further non-limiting embodiment of any of the foregoing methods, the controlling step includes determining whether the wireless charging system is available for charging the battery pack.

In a further non-limiting embodiment of any of the foregoing methods, the method includes ending the charging if power is unavailable from either the wired charging system or the wireless charging system.

In a further non-limiting embodiment of any of the foregoing methods, the controlling step includes determining whether a power cord of the wired charging system is plugged in.

In a further non-limiting embodiment of any of the foregoing methods, the controlling step includes determining whether wall power is available for powering the wired charging system.

In a further non-limiting embodiment of any of the foregoing methods, the method includes charging the battery pack using the wired charging system if the wall power is available or determining whether power is available from the wireless charging system if the wall power is not available.

In a further non-limiting embodiment of any of the foregoing methods, the method includes charging the battery pack using power from the wireless charging system if the wireless charging system is available.

In a further non-limiting embodiment of any of the foregoing methods, the method includes permitting the charging only when a mechanical restraint of the electrified vehicle is actuated.

A vehicle system according to another exemplary aspect of the present disclosure includes, among other things, a battery pack, a wireless charging system configured to selectively charge the battery pack, a wired charging system configured to selectively charge the battery pack and a control system configured to prioritize charging of the battery pack using the wired charging system over the wireless charging system when both are available.

In a further non-limiting embodiment of the foregoing vehicle system, the wireless charging system is an inductive charging system that includes a transmitter device and a receiver device.

In a further non-limiting embodiment of either of the foregoing vehicle systems, the control system includes at least one control module configured to execute a control strategy for charging the battery pack.

In a further non-limiting embodiment of any of the foregoing vehicle systems, the wired charging system includes a charging port and a power cord configured to connect between the charging port and a wall receptacle of an external power source.

In a further non-limiting embodiment of any of the foregoing vehicle systems, the control system is configured to command charging using the wireless charging system if the wired charging system becomes unavailable.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates a powertrain of an electrified vehicle.

FIG. 2 illustrates a vehicle system of an electrified vehicle.

FIG. 3 schematically illustrates a control strategy for controlling charging of an electrified vehicle.

### DETAILED DESCRIPTION

This disclosure describes a vehicle system and method for controlling charging of an electrified vehicle. An exemplary charging control strategy includes prioritizing wired charging over wireless charging if power is available from both charging systems. A vehicle system for executing the prioritization scheme is also contemplated. These and other features are discussed in greater detail in the following paragraphs of this detailed description.

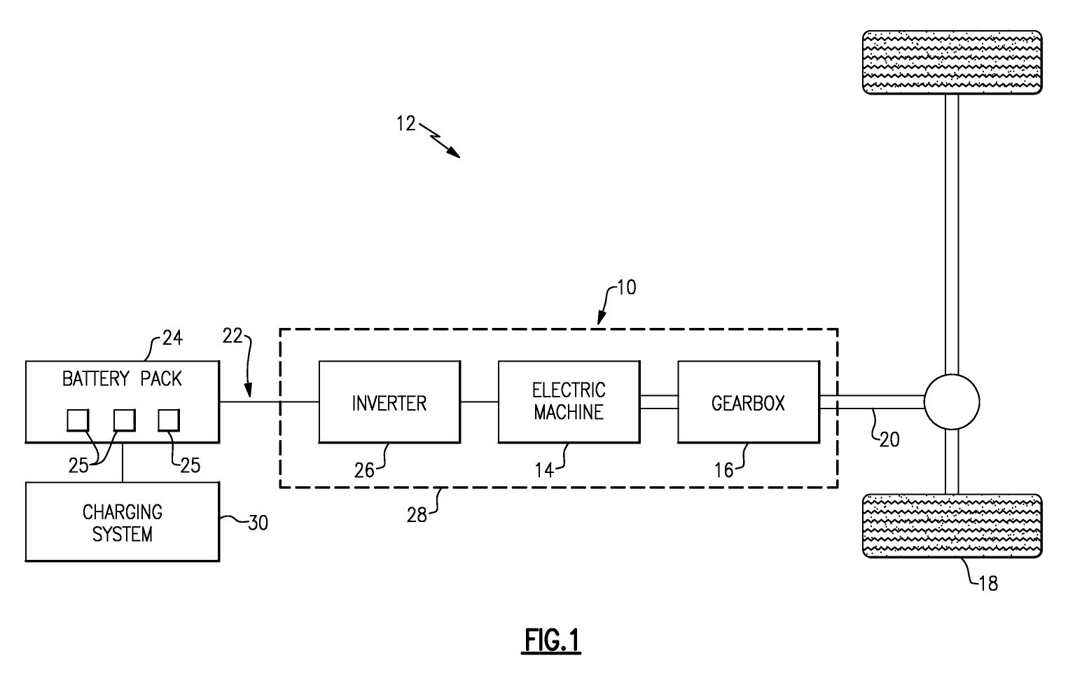

FIG. 1 schematically illustrates a powertrain 10 of an electrified vehicle 12. Although depicted as a battery electric vehicle (BEV), it should be understood that the concepts described herein are not limited to BEV's and could extend to other electrified vehicles, including but not limited to, plug-in hybrid electric vehicles (PHEV's). Therefore, although not shown in this embodiment, the electrified vehicle 12 could be equipped with an internal combustion engine that can be employed either alone or in combination with other energy sources to propel the electrified vehicle 12.

In one non-limiting embodiment, the electrified vehicle 12 is a full electric vehicle propelled solely through electric power, such as by an electric machine 14, without assistance from an internal combustion engine. The electric machine 14 may operate as an electric motor, an electric generator, or both. The electric machine 14 receives electrical power and provides a rotational output power. The electric machine 14 may be connected to a gearbox 16 for adjusting the output torque and speed of the electric machine 14 by a predetermined gear ratio. The gearbox 16 is connected to a set of drive wheels 18 by an output shaft 20. A high voltage bus 22 electrically connects the electric machine 14 to a battery pack 24 through an inverter 26. The electric machine 14, the gearbox 16, and the inverter 26 may collectively be referred to as a transmission 28.

The battery pack 24 is an exemplary electrified vehicle battery. The battery pack 24 may be a high voltage traction battery pack that includes a plurality of battery assemblies 25 (i.e., battery arrays or groupings of battery cells) capable of outputting electrical power to operate the electric machine 14 and/or other electrical loads of the electrified vehicle 12. Other types of energy storage devices and/or output devices can also be used to electrically power the electrified vehicle 12.

The electrified vehicle 12 may also include a charging system 30 for charging the energy storage devices (e.g., battery cells) of the battery pack 24. The charging system 30 may be connected to an external power source (not shown) for receiving and distributing power. The charging system 30 may also be equipped with power electronics used to convert AC power received from the external power supply to DC power for charging the energy storage devices of the battery pack 24. The charging system 30 may also accommodate one or more conventional voltage sources from the external power supply (e.g., 110 volt, 220 volt, etc.). The charging system 30 could include a wired charging system, a wireless charging system, or both.

The powertrain 10 shown in FIG. 1 is highly schematic and is not intended to limit this disclosure. Various additional components could alternatively or additionally be employed by the powertrain 10 within the scope of this disclosure.

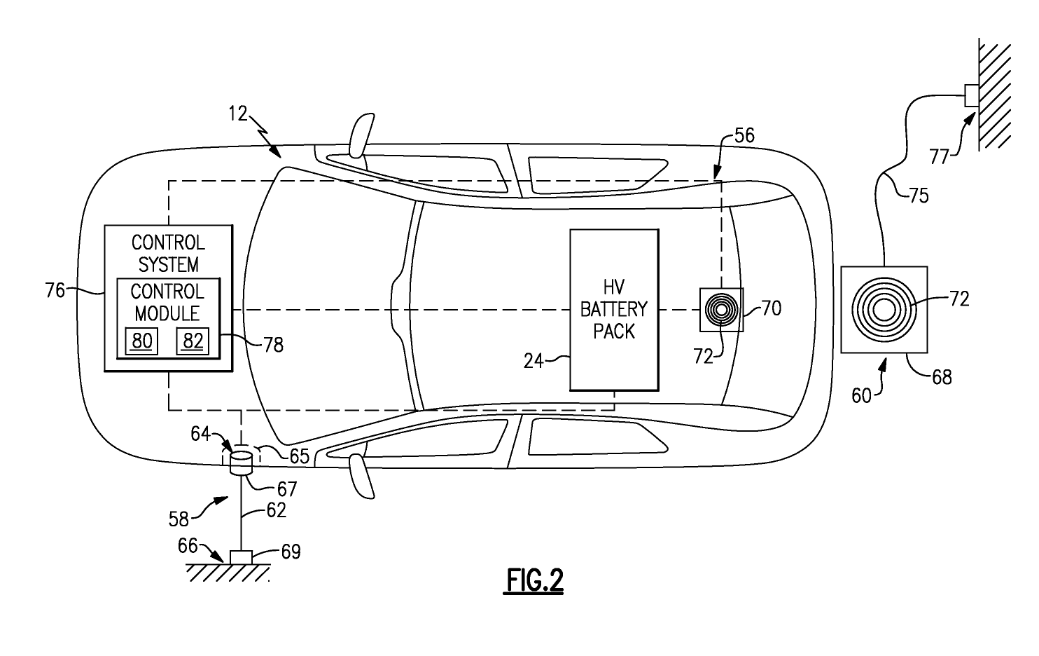

FIG. 2 is a highly schematic depiction of a vehicle system 56 that may be employed within an electrified vehicle, such as the electrified vehicle 12. The vehicle system 56 is adapted to control charging of a high voltage battery pack 24. The various components of the vehicle system 56 are shown schematically to better illustrate the features of this disclosure and are not necessarily depicted in their exact location in an actual vehicle.

In one non-limiting embodiment, the exemplary vehicle system 56 includes the battery pack 24, a wired charging system 58, a wireless charging system 60, and a control system 76. The battery pack 24 may include one or more battery assemblies each having a plurality of battery cells or other energy storage devices. The energy storage devices of the battery pack 24 store electrical energy that is selectively supplied to power various electrical loads residing onboard the electrified vehicle 12. These electrical loads may include various high voltage loads (e.g., electric machines, etc.) or various low voltage loads (e.g., lighting systems, low voltage batteries, logic circuitry, etc.). The energy storage devices of the battery pack 24 are depleted of energy over time and therefore must be periodically recharged. Recharging can be achieved using either the wired charging system 58 or the wireless charging system 60, details of which being further discussed below.

The wired charging system 58 may include a power cord 62 that connects between a charging port 64 of a vehicle connector 65 and a wall receptacle 66 of an external power source (e.g., grid power). The power cord 62 includes a first plug 67 for connecting to the charging port 64 and a second plug 69 for connecting to the wall receptacle 66. Power from the external power source may be transferred to the electrified vehicle 12 for charging the energy storage devices of the battery pack 24 via the power cord 62. The wired charging system 58 may be equipped with power electronics configured to convert AC power received from the external power source to DC power for charging the energy storage devices of the battery pack 24. The wired charging system 58 may be configured to accommodate one or more conventional voltage sources from the external power source (e.g., 110 volt, 220 volt, etc.).

In one non-limiting embodiment, the wireless charging system 60 communicates power via electromagnetic induction and may be referred to as an inductive charging system. The exemplary wireless charging system 60 may include a transmitter device 68 and a receiver device 70. The transmitter device 68, which is located separate from the electrified vehicle 12, is configured to wirelessly communicate power, and the receiver device 70, which is vehicle mounted, is configured to receive the power. A power cord 75 may connect the transmitter device 68 to a wall receptacle 77 for receiving power from an external power source. In one non-limiting embodiment, both the transmitter device 68 and the receiver device 70 include coils 72 for wirelessly transferring power between the transmitter device 68 and the receiver device 70. The power received by the receiver device 70 is then transferred to the battery pack 24 for replenishing the charge of the energy storage devices housed therein.

In one non-limiting embodiment, the transmitter device 68 of the wireless charging system 60 is positioned at a location where the electrified vehicle 12 is frequently parked, such as on a garage floor, parking space or other location. The electrified vehicle 12 may be maneuvered into position over the transmitter device 68 to locate the receiver device 70 in close proximity to the transmitter device 68 such that power can be transferred therebetween. This is shown in a highly schematic manner, and a person of ordinary skill in the art having the benefit of this disclosure would understand how to wirelessly charge the electrified vehicle 12.

The control system 76 of the vehicle system 56 is operable to control charging of the battery pack 24. For example, as further discussed below, the control system 76 may control charging of the battery pack 24 by prioritizing charging via the wired charging system 58 over the wireless charging system 60 when both systems are available. The control system 76 may also control when to enable and disable charging, the length of charging, the power levels of the charging, etc.

The control system 76 may be part of an overall vehicle control system or could be a separate control system that communicates with the vehicle control system. The control system 76 includes one or more control modules 78 equipped with executable instructions for interfacing with and commanding operation of various components of the vehicle system 56. For example, in one non-limiting embodiment, each of the battery pack 24, the wired charging system 58 and the wireless charging system 60 includes a control module, and these control modules communicate with one another to control charging of the battery pack 24. In another non-limiting embodiment, each control module 78 includes a processing unit 80 and non-transitory memory 82 for executing the various control strategies and modes of the vehicle system 56. Once such control strategy is discussed below.

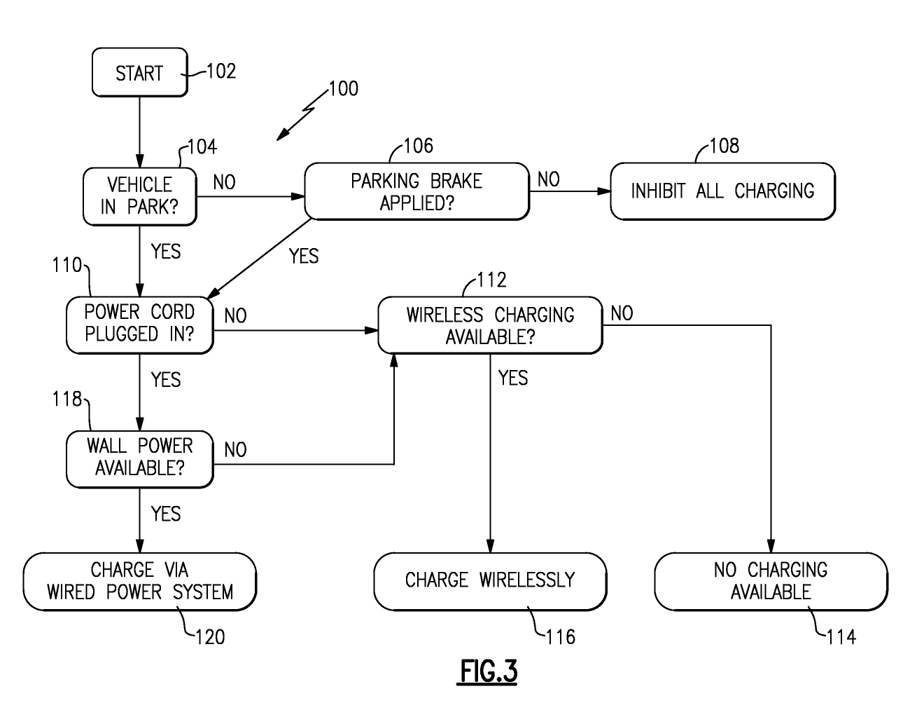

FIG. 3, with continued reference to FIGS. 1 and 2, schematically illustrates a control strategy 100 for controlling the vehicle system 56 of the electrified vehicle 12. For example, the control strategy 100 can be performed to control charging of the electrified vehicle 12. In one non-limiting embodiment, the control system 76 is programmed with one or more algorithms adapted to execute the exemplary control strategy 100, or any other control strategy. In another non-limiting embodiment, the control strategy 100 is stored as executable instructions in the non-transitory memory 82 of the control module(s) 78 of the control system 76.

The control strategy 100 begins at block 102. At block 104, the control strategy 100 determines whether the electrified vehicle 12 is parked. In one non-limiting embodiment, the control system 76 may communicate with a powertrain control system and/or other control systems of the electrified vehicle 12 to determine whether a gear shift device of the electrified vehicle 12 is positioned in PARK. Sensors and other modules can be used to determine whether the electrified vehicle 12 is parked. If not in PARK, the control strategy 100 next determines whether a parking brake of the electrified vehicle 12 is applied at block 106. In one non-limiting embodiment, the parking brake is an electronic parking brake. If the parking brake is not applied and the electrified vehicle 12 is not in PARK, charging of the electrified vehicle 12 is inhibited at block 108. Enabling charging only when in PARK or when the parking brake (i.e., a mechanical restraint) is applied prevents vehicle rollaway situations. Charging may also be temporarily inhibited in other situations, such as when a driver is shifting out of PARK. Charging may be permitted again upon shifting back to PARK from a non-PARK gear.

Alternatively, if the electrified vehicle 12 is found to be in PARK at block 104 or if the parking brake is found to be applied at block 106, the control strategy 100 may proceed to block 110 by determining whether the power cord 62 of the wired charging system 58 is plugged into both the wall receptacle 66 and the charging port 64 of a vehicle connector 65. This may be determined, for example, by detecting current or voltage coming into the vehicle connector 65. If the power cord 62 is determined to be unplugged in at block 110, the control strategy 100 proceeds to block 112 by determining whether wireless power is available from the wireless charging system 60. This may be determined by sensing signals communicated from the wireless charging system 60, for example. If wireless charging is also not available at block 112, the control strategy 100 ends at block 114 by indicating that no charging is available. However, if wireless charging is available at block 112, the control strategy 100 may proceed to block 116 by wirelessly charging the battery pack 24 of the electrified vehicle 12 using the wireless charging system 60.

If alternatively the power cord 62 of the wired charging system 58 is detected as being plugged in at block 110, the control strategy 100 proceeds to block 118 and determines whether wall power from an external power source is available. If wall power is not available at block 118, the control strategy 100 may again proceed to block 112 by determining whether inductive charging is available. However, if wall power is available at block 118, the control strategy 100 then proceeds to block 120 and charges the battery pack 24 of the electrified vehicle 12 using the wired charging system 58.

The exemplary control strategy 100 prioritizes wired charging over wireless charging when both are available. Fewer losses are associated with wired charging as compared to wireless charging. If, however, power from the wired charging system 58 is somehow lost during charging (e.g., blown fuse, power cord 62 not properly plugged in, etc.), the control system 76 may switch to wireless charging, if available, by commanding the wireless charging system 60 into operation to charge the battery pack 24.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A method, comprising:
controlling charging of a battery pack of an electrified vehicle including prioritizing charging using a wired charging system over a wireless charging system if power is available from both the wired charging system and the wireless charging system.

2. The method as recited in claim 1, comprising inhibiting the charging if the electrified vehicle is not in park.

3. The method as recited in claim 1, comprising inhibiting the charging if a parking brake is not applied.

4. The method as recited in claim 1, comprising inhibiting the charging if the electrified vehicle is not in park and a parking brake is not applied.

5. The method as recited in claim 1, comprising switching to wireless charging using the wireless charging system if power from the wired charging system becomes unavailable.

6. The method as recited in claim 1, comprising:
determining whether the electrified vehicle is in PARK;
determining whether a parking brake of the electrified vehicle is applied; and
inhibiting the charging if the electrified vehicle is not in PARK and the parking brake is not applied.

7. The method as recited in claim 1, wherein the controlling step includes determining whether the wired charging system is available for charging the battery pack.

8. The method as recited in claim 7, comprising charging the battery pack using the wireless charging system if the wired charging system is unavailable.

9. The method as recited in claim 1, wherein the controlling step includes determining whether the wireless charging system is available for charging the battery pack.

10. The method as recited in claim 1, comprising ending the charging if power is unavailable from either the wired charging system or the wireless charging system.

11. The method as recited in claim 1, wherein the controlling step includes determining whether a power cord of the wired charging system is plugged in.

12. The method as recited in claim 1, wherein the controlling step includes determining whether wall power is available for powering the wired charging system.

13. The method as recited in claim 12, comprising:
charging the battery pack using the wired charging system if the wall power is available; or
determining whether power is available from the wireless charging system if the wall power is not available.

14. The method as recited in claim 13, charging the battery pack using power from the wireless charging system if the wireless charging system is available.

15. The method as recited in claim 1, comprising permitting the charging only when a mechanical restraint of the electrified vehicle is actuated.

16. A vehicle system, comprising:
a battery pack;
a wireless charging system configured to selectively charge said battery pack;
a wired charging system configured to selectively charge said battery pack; and
a control system configured to prioritize charging of said battery pack using said wired charging system over said wireless charging system when both are available.

17. The vehicle system as recited in claim 16, wherein said wireless charging system is an inductive charging system that includes a transmitter device and a receiver device.

18. The vehicle system as recited in claim 16, wherein said control system includes at least one control module configured to execute a control strategy for charging said battery pack.

19. The vehicle system as recited in claim 16, wherein said wired charging system includes a charging port and a power cord configured to connect between said charging port and a wall receptacle of an external power source.

20. The vehicle system as recited in claim 16, wherein said control system is configured to command charging using said wireless charging system if said wired charging system becomes unavailable.
